(19) United States
(12) Patent Application Publication
(10) Pub. No.: US 2012/0180014 A1
(43) Pub. Date: Jul. 12, 2012

(54) METHOD OF CONTEXT-SENSITIVE, TRANS-REFLEXIVE INCREMENTAL DESIGN RULE CHECKING AND ITS APPLICATIONS

(75) Inventors: Min-Yi Fang, Hsinchu City (TW); Ssu-Ping Ko, Hsinchu City (TW); Cheng-Ming Wu, Hsinchu City (TW); Chun-Chen Chen, Hsinchu County (TW); Tsung-Ching Lu, Kaohsiung City (TW); Tung-Chieh Chen, Taipei City (TW); Yu-Chi Su, Hsinchu City (TW)

(73) Assignees: SPRINGSOFT, INC., Hsinchu City (TW); SPRINGSOFT USA, INC., San Jose, CA (US)

(21) Appl. No.: 13/277,229

(22) Filed: Oct. 20, 2011

Related U.S. Application Data
(60) Provisional application No. 61/430,184, filed on Jan. 6, 2011.

(51) Int. Cl. G06F 17/50

(52) U.S. Cl. 716/112

(57) ABSTRACT

A computer-implemented method to perform context-sensitive incremental design rule checking (DRC) for an integrated circuit (IC). An incremental DRC engine checks design rule violations between a set of environment shapes and a set of active shapes. If no design rule violations are found, the set of active shapes will be added into the set of environment shapes. Furthermore, the incremental DRC engine can be embedded into placement tools, routing tools, or interactive layout editing tools to check design rule violations and help generate DRC error free layouts.

### CROSS REFERENCE TO RELATED APPLICATIONS

This application claims the benefit of priority of U.S. Provisional Application No. 61/430,184, filed Jan. 6, 2011, and titled “Context-Sensitive, Trans-Reflexive, Incremental DRC Checker and its Applications”, the contents of which are herein incorporated by reference in its entirety.

### BACKGROUND OF THE INVENTION

1. Field of the Invention

The invention relates in general to a computer-implemented method for design rule checking (DRC) for integrated circuits (ICs) and, in particular, to a method for incremental design rule checking (DRC) for integrated circuits (ICs).

2. Description of the Prior Art

Design rule checking (DRC) is a vital step in integrated circuit (IC) design. When turning over an IC design to manufacturing, all design rules required by the manufacturing facility have to be checked and passed. Foundries such as TSMC, UMC and etc publish a set of design rules for each of their process lines. IC designers need to check their designs against these rules before they can hand over to the foundry to start manufacturing.

Traditionally, DRC runs are batch oriented. Designers prepare a command script, commonly known as “rule deck”, and submit it along with their design to a DRC program. The DRC program then interprets the command script, checks the design accordingly, and reports any design rule violations it may detect. Designers then read the design rule violation report and decide how to fix design rule violations. After the design rule violations are fixed, designers rerun the DRC program on the revised design. The process repeats until no design rule violations are reported. The condition is then called “DRC free”, and the design is ready to “tape-out” for manufacturing. DRC in this case is used as a “signed-off” means between the design team and the manufacturing facilities.

As IC designs get more and more complicated, design rule violations toward the end of the design cycle become more and more difficult to fix. It will be ideal if the design is DRC free along the course of the design cycle. That is, the design is “correct by construction”. Automation design tools, such as placement and route tools, will try to deliver correct by construction for the results they generate. In the past, design rules tended to be less complicated, and placement and routing tools could achieve DRC free by taking into account all the design rules in their placement and routing algorithms. However, modern process nodes (e.g. 40 nm and beyond) requires advanced rules that are hard, if not impossible, to be fully taken care of in placement and routing algorithms. To achieve correct by construction, software tools will try to take care of design rules in algorithms as much as possible. In addition, they need an embedded DRC engine to help detect if there are any design rule violations that they might generate. If the embedded DRC engine reports design rule violations, software tools will then try to revise the results to avoid the design rule violations.

The same idea of correct by construction can be applied to manual editing of IC layouts. During manual editing, designers may want to ensure that they are not causing new design rule violations. To achieve this goal, layout editors will need embedded DRC engines to help check DRC violations, and possibly guide the user during manual editing.

What the embedded DRC engine does is usually called “incremental” design rule checking. In prior art, it's not uncommon that incremental DRC and sign-off DRC share the same piece of software program: only the rule set and the size of the geometry shapes differ. For incremental DRC, the rule set may be a subset of the entire set of design rules, and the geometry shapes may come from a portion of the design. Other than those two, the checking and report mechanisms are the same.

There are several drawbacks using the sing-off DRC approach for incremental DRC. Firstly, the “newly created” design rule violations are mixed with “old” design rule violations in the DRC report. Take the placement and routing tools as an example. If the partial design that the tool passes to the DRC engine does not contain any design rule violations, everything will be fine. On the other hand, if the partial design contains both new design rule violations, which are caused by the tool's latest actions, and old design rule violations, which have been sitting there before the tool applies the latest actions, it will be confusing to the user. Often, the user has to run incremental DRC twice: first on the partial design before the actions, and second on the partial design after the actions. Design rule violations common to these two runs are then filtered out. Although this can yield the newly created design rule violations, it's time consuming and error prone.

The second drawback is about efficiency. Sometimes a tool that makes use of incremental DRC wants to make sure that no new design rule violations are introduced by its actions. That is, as soon as the first design rule violation is detected, the tool would like to stop the DRC engine right away, and the tool will rollback what it has done to the design and try something else. The sign-off DRC approach, since it is batch oriented, will find and collect all the design rule violations before it starts to report. When the tool stops the DRC engine on the first design rule violation report, much of the work for DRC checking has been done already. It's a waste of precious runtime.

Therefore, what is needed is a DRC method that can isolate the new DRC violations from the old DRC violations, and can perform DRC in a correct-by-construction manner to deliver overall DRC results efficiently.

### SUMMARY OF THE INVENTION

One object of the present invention is to perform context-sensitive incremental design rule checking (DRC) for an integrated circuit (IC). The design rule violation checking is executed between a set of environment shapes and a set of active shapes but not among the set of environment shapes and the set of active shapes. Furthermore, the checking can comprise multiple transactions. For each transaction, if no design rule violations are found, the set of active shapes is added into the set of environment shapes.

One embodiment in the present invention is to incorporate the context-sensitive incremental DRC engine with placement tools. With the assistance of the context-sensitive incremental DRC engine, placements can be generated with design rule checking to resolve violations during the placement.

In another embodiment of the present invention, the context-sensitive incremental DRC engine can provide users with guidance for DRC-free editing in an interactive editing layout tool.

Another embodiment in the present invention is to incorporate the context-sensitive incremental DRC engine with net routing tools. With the assistance of the context-sensitive incremental DRC engine, nets can be routed along with efficient design rule checking to resolve violations during the routing process.

Other objects, technical contents, features and advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1 is a schematic flow diagram for context-sensitive incremental design rule checking;

FIG. 2 illustrates an example for context-sensitive incremental design rule checking for an integrated circuit (IC);

FIG. 3 is a schematic flow diagram for generating placements with context-sensitive incremental design rule checking;

FIG. 4A to FIG. 4E illustrate an example for generating placements with context-sensitive incremental design rule checking;

FIG. 5A to FIG. 5C illustrate an example for moving an geometry shape in an interactive layout editing tool guided with context-sensitive incremental design rule checking;

FIG. 6 is a schematic flow diagram for generating net routes with context-sensitive incremental design rule checking;

FIG. 7A to FIG. 7C illustrate an example for generating net routes with context-sensitive incremental design rule checking; and

FIG. 8A to FIG. 8D illustrate an example for replacing vias with context-sensitive incremental design rule checking.

### DETAILED DESCRIPTION OF THE INVENTION

The detailed explanation of the present invention is described as following. The described preferred embodiments are presented for purposes of illustrations and description, and they are not intended to limit the scope of the present invention.

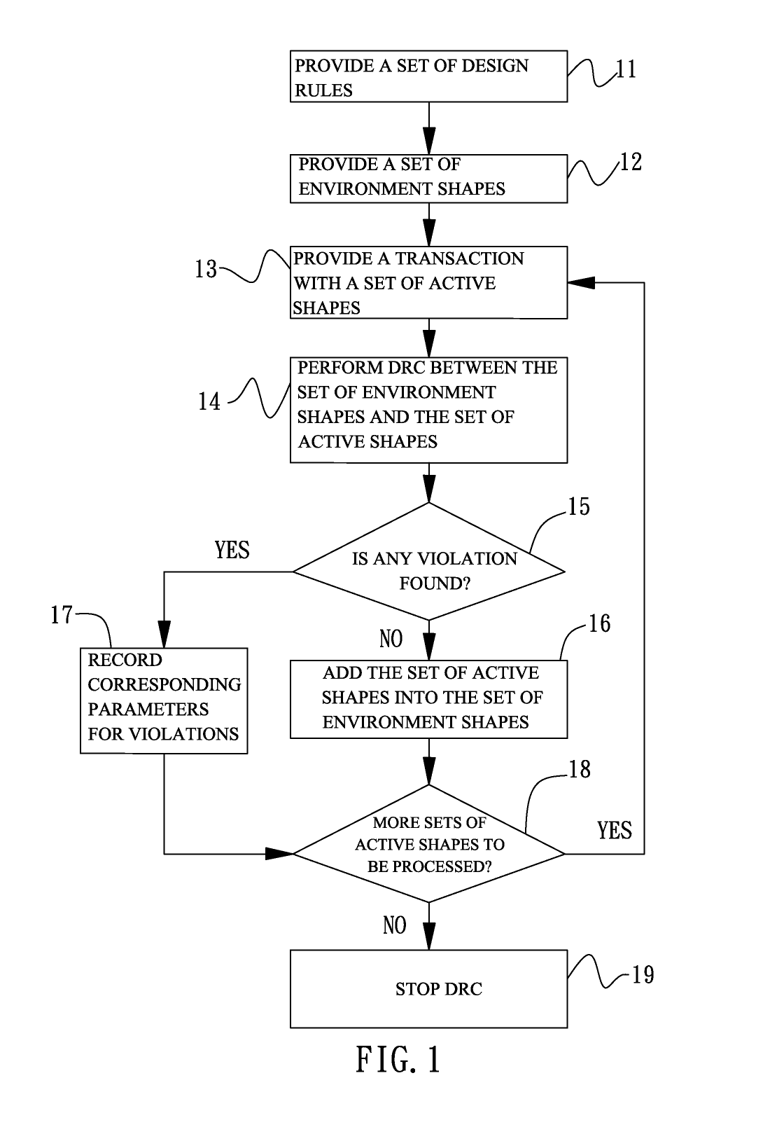

FIG. 1 illustrates a basic schematic flow diagram of the smart incremental design rule checking (DRC) for an integrated circuit (IC) which comprises a plurality of geometry shapes, wherein each of the geometry shapes bounds, in whole or in part, a cell instance, a device, a wire, a contact, or etc in the IC, and the plurality of geometry shapes may overlap.

During initialization, design rules to be checked are passed to the DRC engine (step 11). Then, a set of environment shapes are passed to the engine (step 12). Typically, the set of environment shapes are existing geometry shapes in the IC. After the set of environment shapes are added to the engine, a transaction is started. Then, a set of active shapes are passed to the DRC engine (step 13). Typically, the set of active shapes are geometry shapes which are to be added to the IC. After the set of active shapes are added to the DRC engine, design rule checking can be started (step 14). Since the main target is to find design rule violations between the set of environment shapes and the set of active shapes, the checking will only be performed on potential design rule violations between the set of environment shapes and the set of active shapes. In other words, it is not necessary to check potential design rule violations within the set of environment shapes or within the set of active shapes.

If design rule violations are found during checking (step 15), the corresponding parameters will be recorded (step 17) for error reporting, and the transaction is terminated without a commit. Otherwise, the set of active shapes will be added into the set of environment shapes, and the transaction is terminated and committed (step 16). If more sets of active shapes are to be processed (step 18), the next transaction will be started; otherwise, the design rule checking will be stopped (step 19).

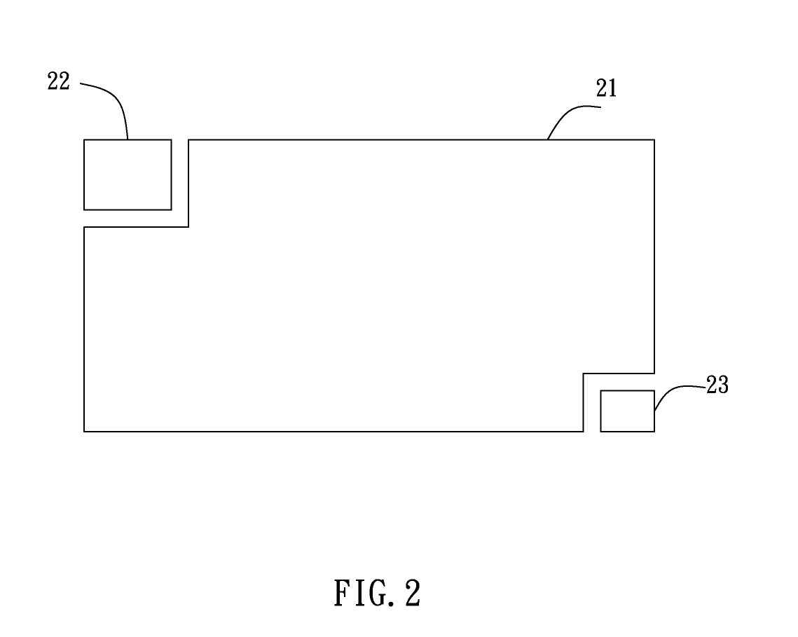

In one embodiment, the incremental DRC can be applied to an IC which is almost DRC free but still needs some checking for small portions of geometries. As an example shown in FIG. 2, an IC comprises three sets of geometry shapes. The first set of geometry shapes 21 is defined as a set of environment shapes. The second set of shapes 22 and third set of shapes 23 are two sets of active shapes which may introduce potential design rule violations against a set of design rules.

According to the flow illustrated in FIG. 1, the set of design rules are first passed to the DRC engine. Then, the first set of geometry shapes 21 and the second set of shapes 22 are also passed to the engine. Thus a first transaction is started for design rule checking between the first set of geometry shapes 21 and the second set of shapes 22 according to the set of design rules. If no design rule violations are founded, the second set of shapes 22 can be added to the first set of geometry shapes 21 as an updated set of environment shapes. Otherwise, the information and parameters associated with the design rule violations will be recorded.

Next, the third set of shapes 23 is passed to the engine. Therefore, a second transaction is started for design rule checking between the third set of shapes 23 and current set of environment shapes, which is either the updated set of environment shapes (21 and 22) or the original set of environment shapes (21) depending on the previous checking result. If no design rule violations are found, the third set of shapes 23 can be added to the current set of environment as an updated set of environment shapes. Otherwise, the parameters associated with each of the design rule violations will be recorded. Consequently, the incremental design rule checking process for the IC is completed.

The disclosed DRC engine is suitable for embedding in various electronic design automation (EDA) tools. The rest of the descriptions will cover how such an incremental DRC engine can be embedded in and utilized by various tools, such as placement tools, routing tools, or interactive layout editing tools.

In one embodiment, the DRC engine is incorporated with a placement tool. Given an IC comprising a plurality of cell instances, a placement tool is to assign the location and orientation to each of the cell instances in the IC subject to a set of design rules.

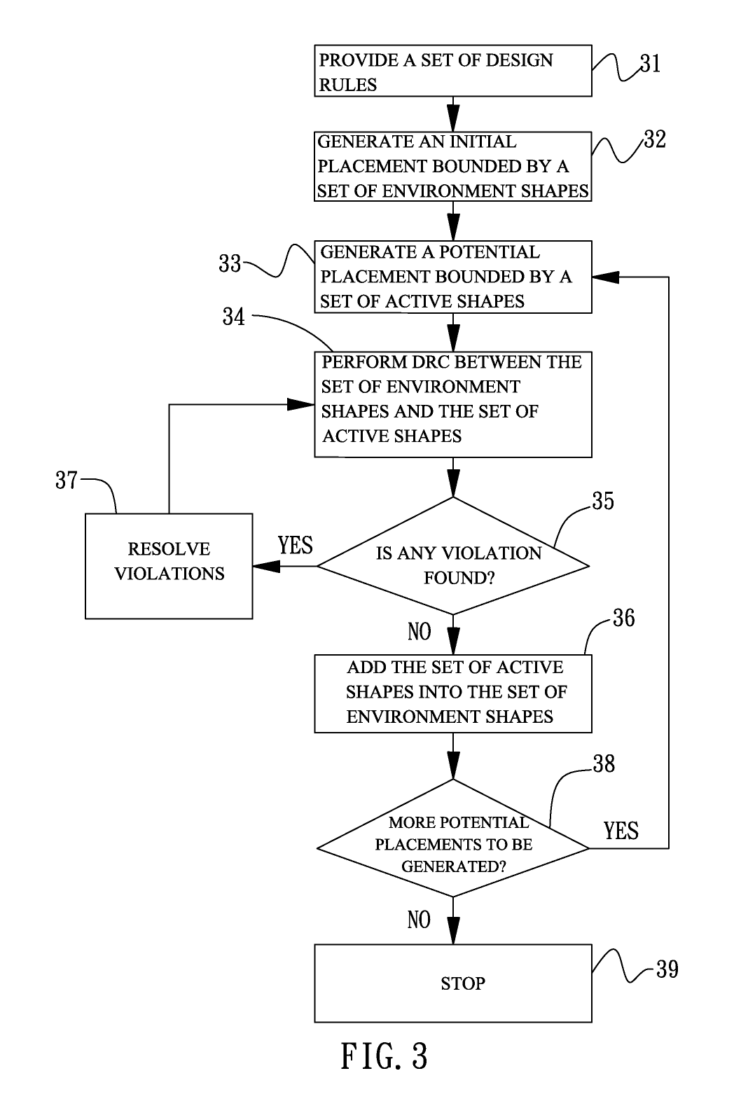

FIG. 3 depicts a schematic flow diagram for generating placements with incremental design rule checking. First, the set of design rules are passed to the DRC engine (step 31). Next, a portion of cell instances are defined as a set of environment shapes and passed to DRC engine (step 32). Then, a set of cell instances which is not included in the set of environment shapes are defined as a set of active shapes and passed to DRC engine (step 33).

Thus design rule checking can be performed between the set of environment shapes and the set of active shapes but not within the set of environment shapes or within the set of active shapes according the design rules (step 34). If no design rule violations are found (step 35), the set of active shapes will be added into the set of environment shapes (step 36). If design rule violations are found (step 35), detailed results will be generated, which comprise the involved cell instances and corresponding geometric parameters for resolving design rule violations. According to the results, the set of active shapes can be re-placed (step 37) and the design rule checking will be re-done, until the design rule violations are resolved.

After the set of active shapes are added into the set of environment shapes, a new set of active shapes can be defined and processed until all the cell instances are successfully converted to the set of environment shapes (step 38 and 39).

In one embodiment, callback functions are used for passing design rule violations generated in step 35. During initialization, a plurality of callback functions are registered for corresponding potential design rule violations. Thus, in step 35, once design rule violations are found, a corresponding callback function will be called for each of the design rule violations to pass the associated information and parameters to trigger the action for resolving the design rule violation.

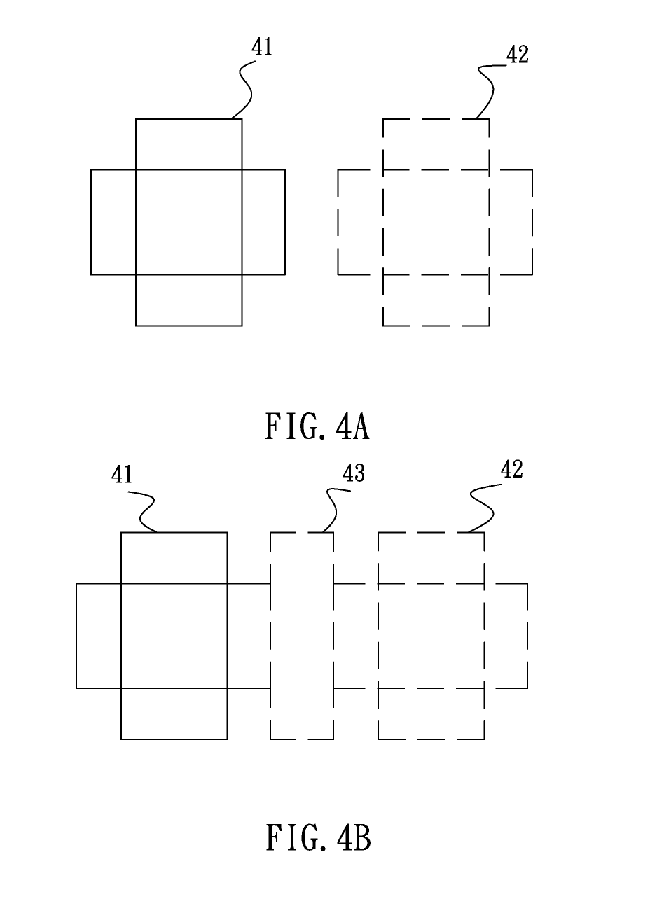

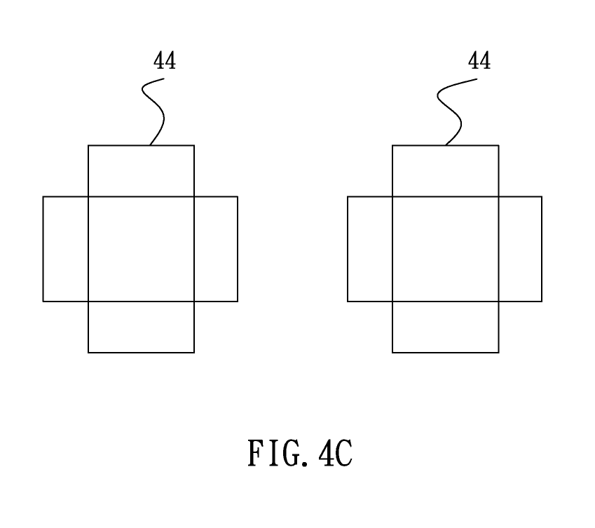

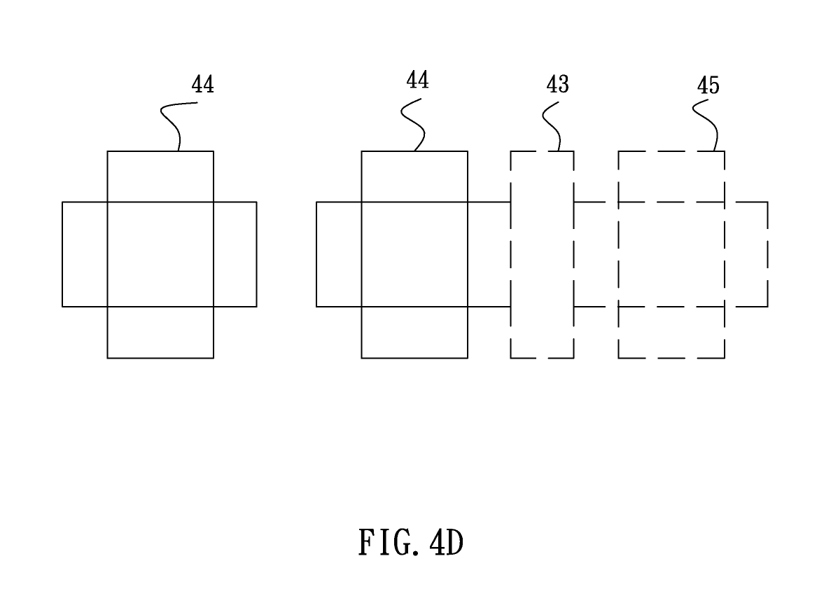

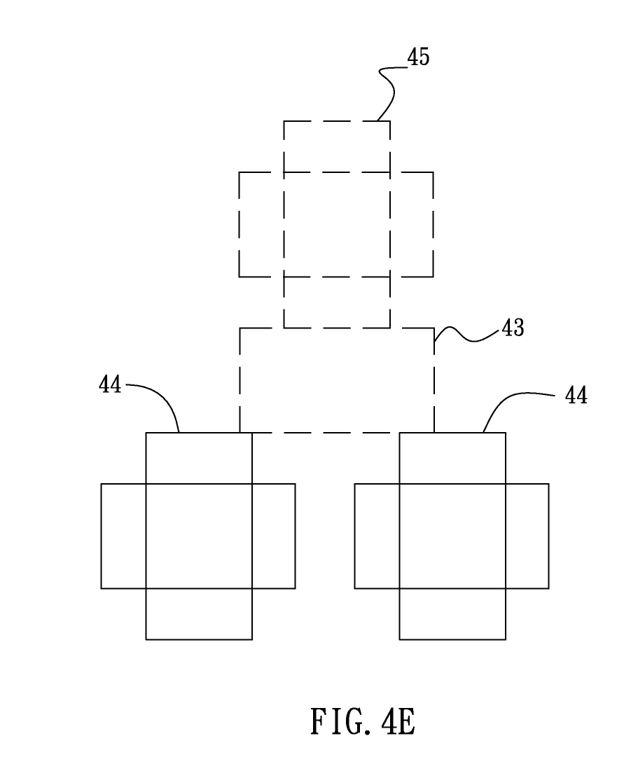

FIG. 4A to FIG. 4E demonstrate an example for generating placements with incremental design rule checking. To define the set of environment shapes, in one embodiment, the checking starts with a far end along a direction, say the far left on horizontal direction. Geometry shapes in the master cells corresponding to those instances on the far left are retrieved and transformed accordingly. The transformed shapes are passed to the DRC engine as an initial set of environment shapes.

Next, shapes in the master cells corresponding to those instances which are next to those cell instances on the far left are retrieved and transformed accordingly. The transformed shapes are then passed to the DRC engine as a set of active shapes.

In FIG. 4A, the solid boxes 41 are shapes of the cell instance at the far left, which are passed to the DRC engine as the initial set of environment shapes; the boxes with dotted lines 42 are shapes of the cell instance adjacent to the cell instance at the far left, which are passed to the DRC engine as the set of active shapes. Then, the DRC engine is invoked in a transaction to check for design rule violations. Taking “minimum distance” violations as an example, for each of the corresponding violation callbacks, the placement tool creates in its data structure a “clearance” constraint in between the involved cell instances. Thus, the cell instance containing the set of active shapes 42 is to be re-placed according to the “clearance” constraint 43 to resolve the design rule violation, as shown in FIG. 4B.

After all the design rule violations are resolved, the placement tool commits the current transaction with the DRC engine, that is, adding the set of active shapes into the initial set of environment shapes to form an update set of environment shapes 44, as shown in FIG. 4C.

As illustrated in FIG. 4D, the placement tool then starts a new transaction, retrieves shapes in the cell instances 45 adjacent to the cell instances 44 which have just been processed, transforms them accordingly, and passes the results to the incremental DRC engine as a set of active shapes. Then, a new round of incremental DRC is performed. As before, each violation callback will cause the placement tool to generate in its data structure a clearance constraint 43. After all the design rule violations are resolved, the placement commits the DRC transaction, which adds the set of active shapes into the updated set of environment shapes. Then, the placement tool moves on to process the next level of cell instances. The placement tool repeats this process for each level of cell instances in the horizontal direction as illustrated in FIG. 4D.

After that, the placement tool changes the direction, say, to the vertical direction. Again, in one embodiment, the placement tool starts with cell instances from one end, say, from the bottom. As depicted in FIG. 4E, it retrieves all the shapes in the cell instances at the bottom, transforms them, and passes the transformed results to the DRC engine as an initial set of environment shapes 44.

Next, it retrieves all the shapes in the cell instances 45 adjacent to the instances at the bottom, transforms them, and passes the transformed results to the DRC engine as a set of active shapes. Then, incremental DRC is performed. For each violation callback, the placement tool inserts a clearance constraint 43 accordingly.

After all the design rule violations are resolved, the placement tool commits the current transaction, which adds the set of active shapes into the initial set of environment shapes. Then, the placement tool moves on to the next level of cell instances, and repeats the process. It does this until all levels of cell instances are processed.

At this point both the horizontal and vertical design rule violations have been resolved appropriately. The updated placement result should be clear of all the design rule violations which were reported by the incremental DRC engine.

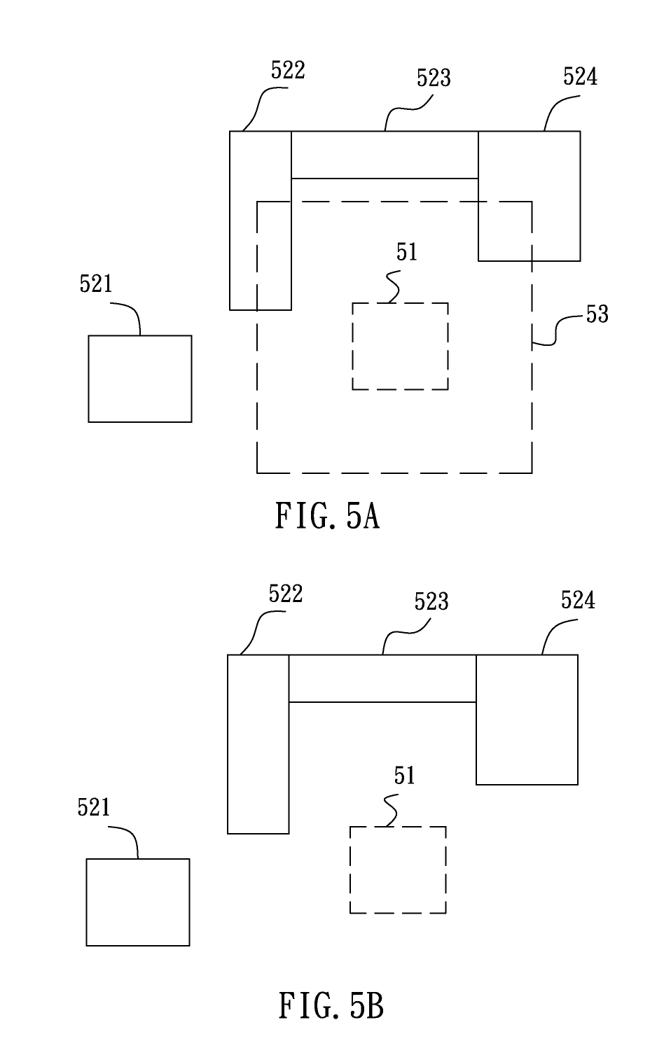

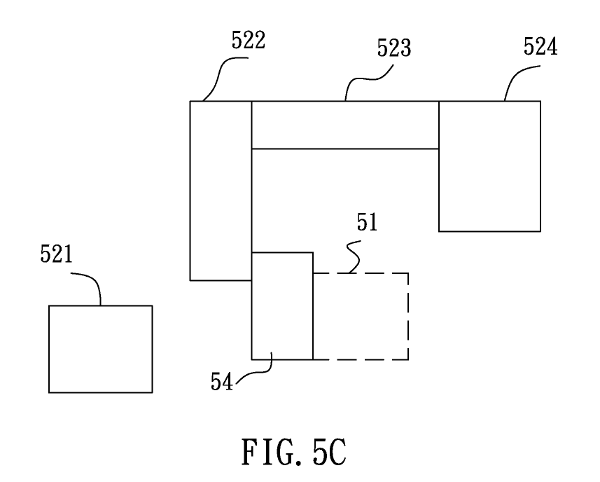

In another embodiment, the DRC engine is incorporated with an interactive layout editing tool. As illustrated in FIG. 5A, box 51 with dotted lines represents the shape being edited interactively (say, by a move or stretch command.) boxes 521, 522, 523 and 524 with solid lines represent existing shapes which may or may not cause design rule violations with respect to the current position of box 51. To decide relevant shapes (that is, shapes that may cause design rule violations with respect to the current position of box 51), a “scan range” (denoted by box 53 with dotted lines) is used that surrounds the shape being edited (box 51). Existing shapes that intersect the scan range box (box 53) are relevant shapes, which are passed to the incremental DRC engine as environment shapes.

As illustrated in FIG. 5B, box 522 and box 524 are environment shapes whereas box 521 and 523 are not. The shape being edited (box 51) is passed to the incremental DRC engine as an active shape. Then, the design rule checking is performed between the environment shapes and the active shape but not within the environment shapes or within the active shape according to a set of design rules. If any design rule violation callback occurs, the layout editor can use the information and parameters passed to the callback function to decide if the shape being edited should be adjusted (i.e. repositioned or resized) in order to clear the design rule violation. If it can be done, then the layout editor will change the position or the shape being edited in accordance with the callback information and parameters to clear the design rule violation.

For efficiency reasons, if the layout editor detects a new position (or new dimension) for the active shape (for example, the user has moved the mouse before the first checking is completed), the layout editor will rollback the transaction as soon as possible due to the fact that the new position (or new dimension) for the active shape will invalidate the current checking. Therefore, it should be cancelled as soon as possible, and a new checking should then be prepared and performed.

When the user has finished the rule-driven editing command (for example, the user has released the mouse button), the final position (or dimension) for the active shape is checked against environment shapes. Any design rule violation reported by the increment DRC engine will then be indicated by an error mark 54 on the layout accordingly, as illustrated in FIG. 5C.

In another embodiment, the DRC engine is incorporated with a net routing tool. Given an IC comprising a plurality of cell instances, a plurality of conductive wires and a netlist, a net routing tool is to create conductive connections among the cell instances in the IC according to the netlist and subject to a set of design rules.

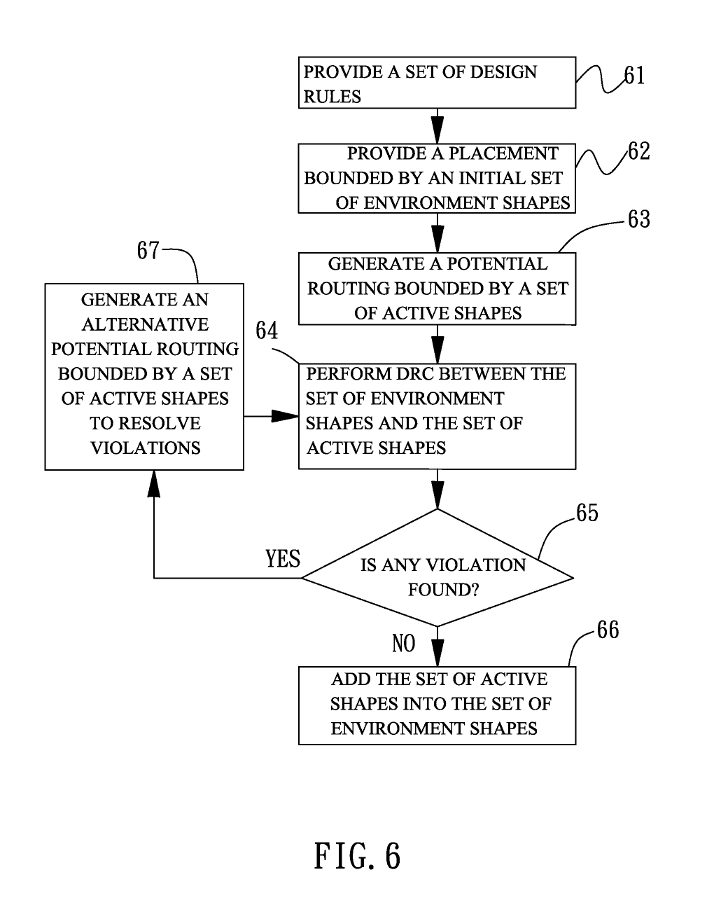

FIG. 6 depicts a schematic flow diagram for generating net routes with incremental design rule checking. First, the set of design rules are passed to the DRC engine (step 61). Next, a placement for a plurality of instances and a portion of conductive wires are defined as a set of environment shapes and passed to DRC engine (step 62 Box 62 needs to mention wires). Then, a potential routing for at least one net with at least one conductive wire which is not included in the set of environment shapes is generated as a set of active shapes and passed to DRC engine (step 63).

Thus design rule checking can be performed between the set of environment shapes and the set of active shapes but not within the set of environment shapes or within the set of active shapes according the design rules (step 64). If design rule violations are found (step 65), the set of active shapes is discarded, and based on the error report from the design rule checking, the router's internal data structure and constraints are updated in accordance with the involved cell instances, conductive wires and corresponding geometric parameters for resolving design rule violations. Accordingly, a new set of active shapes is re-generated (step 67) and the design rule checking will be re-done (step 64), until the design rule violations are resolved.

If design rule violations are not found, the set of active shapes are added into the set of environment set (step 66).

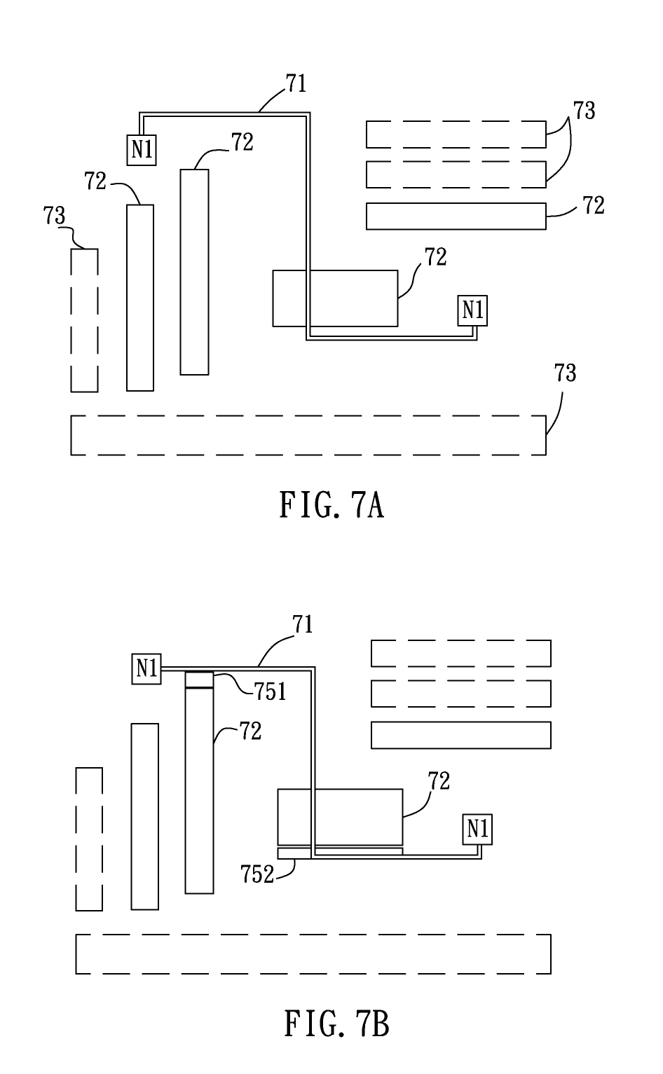

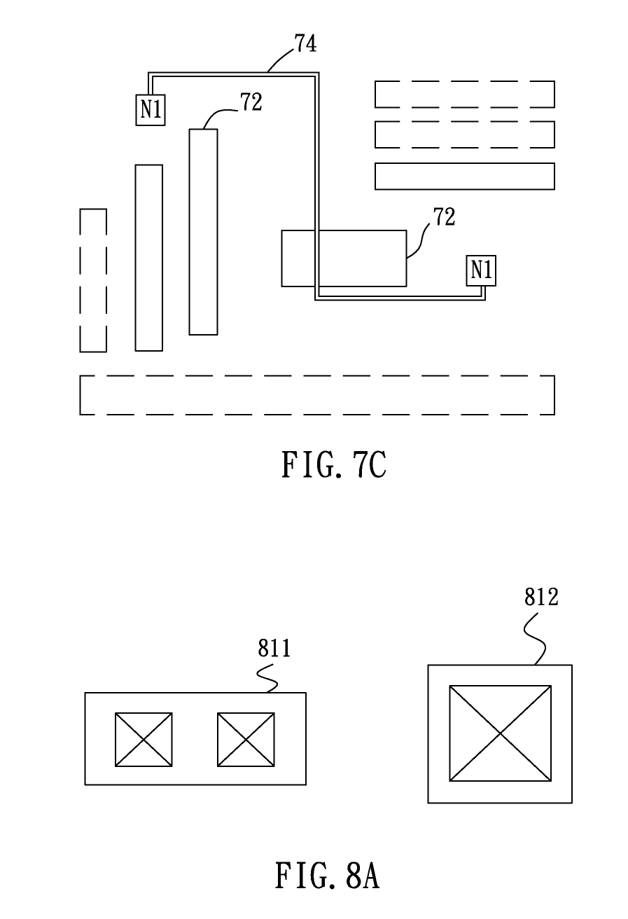

FIG. 7A to FIG. 7C demonstrate an example for one embodiment where the conductive wires are geometry paths. Refer to FIG. 7A. A net routing tool is trying to route net N1 with 2 pins. First, it creates a conductive path 71 to connect the two pins with minimum spacing to go around existing shapes (72 and 73). Then it passes the environment shapes 72 and the active shapes, i.e., the conductive path 71, to the incremental DRC engine. The dotted rectangles 73 are shapes far away from the conductive path 71. Because they will not cause any design rule violations with respect to the conductive path, they will not be passed to the DRC engine, which can speed up the DRC.

After invoking the DRC engine to start checking, the routing tool may receive violation callbacks. Assume that it receives two violation callbacks: one concerning “dense line end” violation and the other concerning “fat spacing violation”, as shown in FIG. 7B.

From the callback data, the router can derive two clearance boxes (751 and 752) which can be added to the router's internal data structure as blockages. The router will then remove conductive path 71 and redo the net routing taking into consideration the two newly added blockages.

After the re-route, the router can generate a new conductive path 74 as show in FIG. 7C. The router will then repeat the aforementioned steps to invoke the incremental DRC engine to check for design rule violations with respect to the new conductive path. If new design rule violations are reported, the router will again add them as new blockages to its data structure, and remove the last conductive path and redo the routing for the net. The router keeps doing this until no design rule violations are reported, or until a pre-determined number of times have been tried without success. In the later case, the router will report to the user that the net cannot be successfully routed.

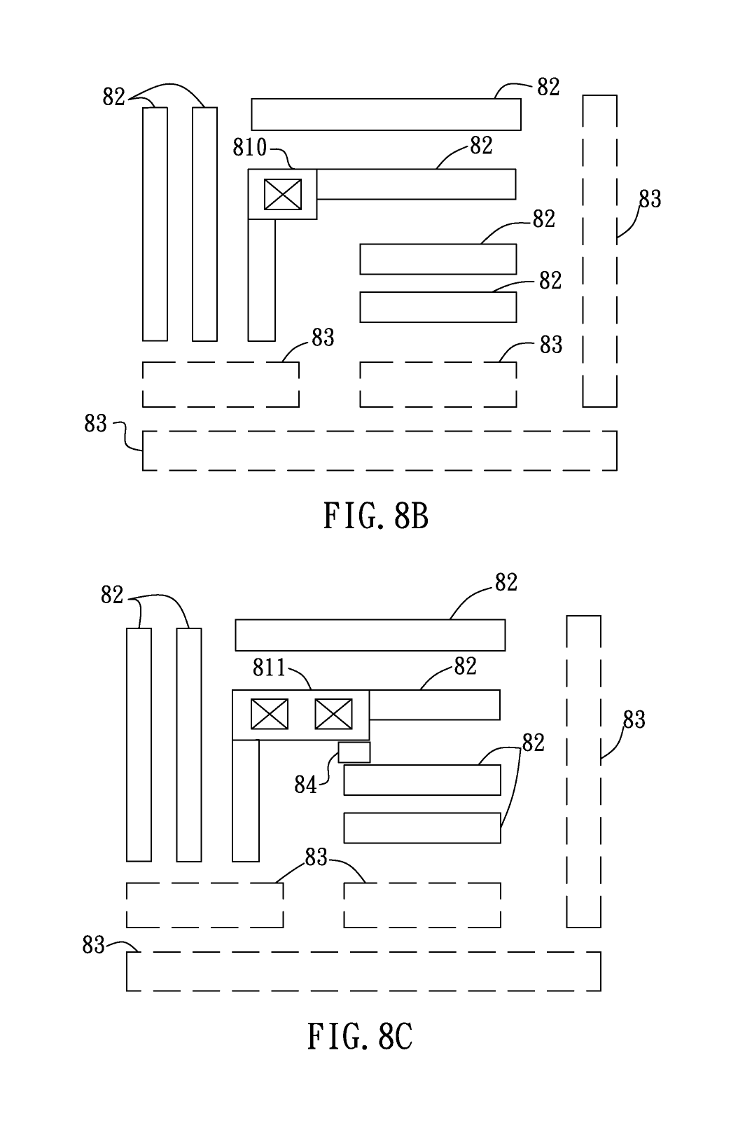

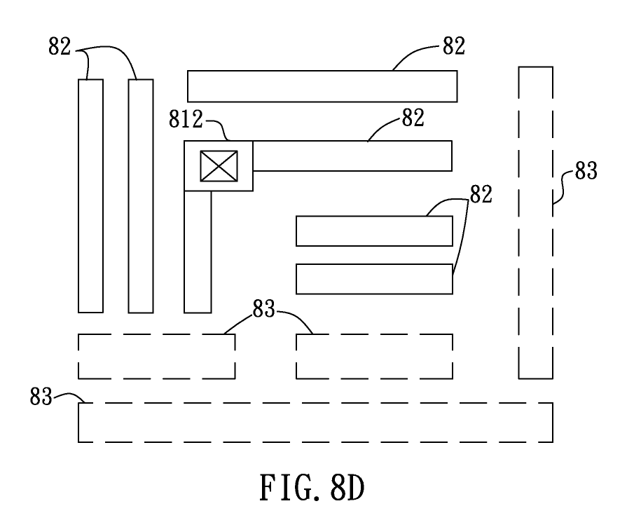

FIG. 8A to FIG. 8D demonstrate an example for another embodiment where the active shapes are vias. A “via” is a small area in an IC layout which connects two adjacent conducting layers (here we treat the poly layer as a conducting layer also.) Geometry-wise, a via consists of three shapes: a “cut” (i.e., the hole that sits in between the two conducting layers) and two enclosures (one for each conducting layer). During manufacturing, a via may suffer from open fault. For example, the cut can get blocked, or the cut may be misaligned with any of the enclosures. Faults greatly impact the yield rate. In order to improve the yield rate, i.e. for design-for-manufacturing (DFM) purposes, foundries often provide a set of preferred vias (DFM vias) for IC designers to use. Because of area concerns, designers can start with a simplest via to complete the layout. After that, a software tool is used to replace simple vias with DFM vias wherever possible.

Please refer to FIG. 8A. Two DFM vias (811 and 812) are used to replace the original via 810 in the design as shown in FIG. 8B. Furthermore, DFM via 811 has a higher priority than DFM via 812.

Refer to FIG. 8C. First, the software tool replaces the original via 810 with DFM via 811. It then adds solid rectangles 82 as environment shapes and the shapes in DFM via 811 as active shapes to the incremental DRC engine, and invokes the design rule checking between the environment shapes and the active shapes but not within the environment shapes or within the active shapes according to a set of design rules. (Again, the tool will not add dotted rectangles 83 to the DRC engine since they are far away from DFM via 811 and will not cause design rule violations as such.) Suppose the tool then receives a violation callback with a design rule violation shown as box 84. On the first violation callback, the tool will immediately notify the DRC engine to rollback the current transaction, which will cause the DRC engine to abort the current checking and discard the active shapes.

Refer to FIG. 8D. After that, the tool will try DFM via 812. The tool will then repeat the aforementioned steps for incremental DRC. If there are no design rule violations, the tool will commit the replacement, and move on to the next via that is a candidate for DMF via replacement. If there are design rule violations reported again, the tool will rollback the replacement, and that via will stay unchanged as via 810 as shown in FIG. 8B.

In summary, the invention provides a context-sensitive way for design rule checking. Consequently, an IC layout can be generated with an efficient process for design rule checking for resolving design rule violations by embedding the context-sensitive incremental DRC engine into various EDA tools.

The foregoing descriptions of specific embodiments of the present invention have been presented for purposes of illustrations and description. They are not intended to be exclusive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to particular use contemplated. It is intended that the scope of the invention be defined by the Claims appended hereto and their equivalents.

What is claimed is:

1. A computer-implemented method for performing incremental design rule checking (DRC) for an integrated circuit (IC), wherein the integrated circuit (IC) comprises a plurality of instances, wherein each of the plurality of instances is bounded, in whole or in part, by at least one of a plurality of geometry shapes, the method comprising using a computer to perform the steps of:
a. providing a set of design rules;
b. providing a set of environment shapes which comprise a portion of the plurality of geometry shapes;
c. providing a first set of active shapes which comprise at least one geometry shape; and
d. performing design rule checking between said at least one geometry shape in the set of active shapes and the set of environment shapes but not within the set of environment shapes or within the set of active shapes according to the set of design rules.

2. The computer-implemented method according to claim 1, further comprising the steps of:
e. adding the set of active shapes into the set of environment shapes if no design rule violations are found; and
f. providing a second set of active shapes which comprise at least one geometry shape; and repeating step d and step e.

3. The computer-implemented method according to claim 1, wherein step d further comprises recording a list of involved geometry shapes and corresponding parameters for each of the design rule violations if design rule violations are found.

4. A computer-implemented method for generating a placement for an integrated circuit (IC) with incremental design rule checking (DRC), wherein the integrated circuit (IC) comprises a plurality of instances, wherein each of the plurality of instances is bounded, in whole or in part, by at least one of a plurality of geometry shapes, the method comprising using a computer to perform the steps of:
a. generating an initial placement for a portion of the plurality of instances, wherein the initial placement is bounded by an initial set of environment shapes that represent all the geometry shapes in the said portion of the plurality of instances;
b. generating a potential placement for at least one instance which is not bounded by the set of environment shapes, wherein the potential placement for the said at least one instance is bounded by a set of active shapes that represent all the geometry shapes in the said at least one instance;
c. performing design rule checking between the set of active shapes and the set of environment shapes but not within the set of environment shapes or within the set of active shapes according to a set of design rules;
d. adding the set of active shapes into the set of environment shapes;
e. repeating step b to step d until the set of environment shapes includes the plurality of instances within the integrated circuit; and
f. re-generating a new placement taking into account the design rule violations found in step c.

5. The computer-implemented method according to claim 4, wherein step c further comprises generating a list of involved shapes and corresponding parameters for each of the design rule violations if design rule violations are found.

6. The computer-implemented method according to claim 5, further comprising registering a plurality of callback functions wherein each of the callback functions is associated with its corresponding design rule violation.

7. The computer-implemented method according to claim 6, wherein step c further comprises calling callback functions to pass the list of involved shapes and the corresponding parameters for each of the design rule violations respectively if design rule violations are found.

8. The computer-implemented method according to claim 7, wherein the corresponding parameters for each of the design rule violations are used to form a clearance constraint between a cell instance in the environment shape and a cell instance in the active shape for the design rule violation.

9. A computer-implemented method for routing for an integrated circuit (IC) with incremental design rule checking (DRC), wherein the integrated circuit (IC) comprises a plurality of instances and a plurality of nets, the method comprising using a computer to perform the steps of:
a. providing a placement for at least a portion of the plurality of instances and a plurality of conductive wires that implement a portion of the plurality of nets, wherein the placement is bounded by an initial set of environment shapes that represent at least a portion of all the geometry shapes in the said portions of the plurality of instances and the plurality of conductive wires;
b. generating a potential routing for at least one net which is not bounded by the set of environment shapes, wherein the potential routing for the said at least one net comprises at least one conductive wire and is bounded by a set of active shapes which comprises at least one geometry shape that represent said at least one conductive wire;
c. performing design rule checking between the set of active shapes and the set of environment shapes but not within the set of environment shapes or within the set of active shapes according to a set of design rules; and
d. adding the set of active shapes into the set of environment shapes if no design rule violations are found in step c, otherwise generating an alternative potential routing for said at least one net to resolve the design rule violations and going back to step c.

10. The computer-implemented method according to claim 9, wherein step c further comprises generating a list of involved shapes and corresponding parameters for each of the design rule violations if design rule violations are found.

11. The computer-implemented method according to claim 9, wherein step d further comprises stopping generating the alternative potential routing if the number of times for generating the alternative potential routing reaches a pre-determined number before the design rule violations are resolved.

12. The computer-implemented method according to claim 9, further comprising registering a plurality of callback functions wherein each of the callback functions is associated with its corresponding design rule violation.

13. The computer-implemented method according to claim 12, wherein step c further comprises calling callback functions to pass the list of involved shapes and the corresponding parameters for each of the design rule violations respectively if design rule violations are found.

14. The computer-implemented method according to claim 13, wherein the corresponding parameters for each of the design rule violations are used to form a blockage constraint corresponding to the design rule violation.

15. The computer-implemented method according to claim 9, wherein the implementation of a net comprises a plurality of conductive wires and vias.

16. A computer-implemented method for performing rule-driven layout editing for an integrated circuit (IC) with incremental design rule checking (DRC), wherein the integrated circuit (IC) comprises a plurality of instances and a plurality of nets, wherein each of the plurality of instances or each of the plurality of nets is bounded, in whole or in part, by at least one of a plurality of geometry shapes, the method comprising using a computer to perform the steps of:
a. editing an object, wherein the object comprises a portion of the plurality of geometry shapes;
b. defining a corresponding set of active shapes which comprise the geometry shapes representing the object and a corresponding set of environment shapes which comprise the geometry shapes surrounding the set of active shapes;
c. performing design rule checking between the set of active shapes and the set of environment shapes but not within the set of environment shapes or within the set of active shapes according to a set of design rules; and
d. repositioning or resizing the object according to the design rule checking results.

17. The computer-implemented method according to claim 16, wherein the object is selected through a user interface (UI).

18. The computer-implemented method according to claim 16, wherein if a new editing action is detected during design rule checking in step c, the current design rule checking is stopped and a new design rule checking is performed according to the result of the new editing action.

19. A computer-implemented method for replacing one of a plurality of vias with a design-for-manufacturing (DFM) via for an integrated circuit (IC) with incremental design rule checking (DRC), wherein the integrated circuit (IC) comprises a plurality of instances and a plurality of nets, wherein each of the plurality of instances or each of the plurality of nets is bounded, in whole or in part, by at least one of a plurality of geometry shapes, wherein a portion of the plurality of nets comprise vias, the method comprising using a computer to perform the steps of:
a. providing at least one design-for-manufacturing (DFM) via arranged in a list in a pre-defined order;
b. replacing said one of a plurality of vias with a first DFM via in the list according to the pre-defined order;
c. defining a corresponding set of active shapes which comprises at least one geometry shape representing the first DFM via and a corresponding set of environment shapes which comprises the geometry shapes surrounding the set of active shapes;
d. performing design rule checking between the set of active shapes and the set of environment shapes but not within the set of active shapes or within the set of environment shapes according to a set of design rules; and
e. if design rule violations are found, restoring the first DFM via with the original via, removing the first DFM via from the list, and repeating step b to step d if the list is not empty.
